(19) United States
(12) Patent Application Publication
(10) Pub. No.: US 2016/0303950 A1
(43) Pub. Date: Oct. 20, 2016

(54) PROTECTIVE DEVICE FOR AN AUTOMOTIVE VEHICLE

(71) Applicant: Jan LEKAR, Ostfildern (DE)

(72) Inventor: Jan LEKAR, Ostfildern (DE)

(21) Appl. No.: 15/092,939

(22) Filed: Apr. 7, 2016

(30) Foreign Application Priority Data
Apr. 14, 2015 (DE) 10 2015 206 661.4

(51) Int. Cl. B60J 1/20

(52) U.S. Cl. CPC B60J 1/2019; B60J 1/2016; B60J 1/2041; B60J 1/205; B60J 1/2061; B60J 1/2066; B60J 1/2063

(57) ABSTRACT

Protective device for a vehicle interior including a flexible two-dimensional structure held on a winding shaft and movable between a pulled-out protective position and a rest position wound-up on the winding shaft. The winding shaft is driven by a motor in both directions of rotation, wherein the two-dimensional structure is provided with a dimensionally stable pull-out profile in the end face region that is in front in the pull-out direction, and a drive transmission arrangement is provided which engages the pull-out profile and is in operative connection with the winding shaft. The winding shaft is associated with a blocking device which is, by control device, movable between a release position, releasing the winding shaft for rotational movement, and a securing position, blocking rotational movement of the winding shaft, in response to a displacement condition of the pull-out profile.

### CROSS-REFERENCE TO RELATED APPLICATIONS

This application claims priority from German Patent Application No. 10 2015 206 661.4, filed on Apr. 14, 2015, the disclosure of which is hereby incorporated by reference in its entirety into this application.

### FIELD OF THE INVENTION

The invention relates to a protective device for an automotive vehicle, in particular for a vehicle interior, comprising a flexible two-dimensional structure, which is held on a winding shaft and is movable between a pulled-out protective position and a rest position wound-up on the winding shaft, wherein the winding shaft is driven by means of a drive motor in both directions of rotation, wherein the two-dimensional structure is provided with a dimensionally stable pull-out profile in the end face region that is in front in the pull-out direction, and wherein drive transmission means are provided, which engage the pull-out profile and are in operative connection to the winding shaft.

### BACKGROUND OF THE INVENTION

A well-known protective device in the form of a shading device for a rear window of a passenger motor vehicle has a flexible two-dimensional structure in the form of a shading structure, which is held on a winding shaft in an end face region. An opposite end face region of the shading structure is provided with a dimensionally stable pull-out profile. The winding shaft is rotatably mounted in a cartridge housing. By means of a corresponding rotating process of the winding shaft, winding off or winding up of the shading structure is achieved as a function of the direction of rotation. In the ready-for-use installed condition the dimensionally stable pull-out profile is displaceably mounted in guide rail arrangements fixed to the vehicle. Within the guide rail arrangements the pull-out profile is displaced in the longitudinal direction using drive transmission means in operative connection to a drive motor. The drive motor is also coupled to the winding shaft, in order to obtain rotational movement of the winding shaft for a corresponding winding up or winding off procedure of the shading structure. In a pulled-out protective position the shading structure is deployed in order to shade the rear window. In the wound-up rest position the shading structure is wound up on the winding shaft and accommodated in the cartridge housing.

### SUMMARY OF THE INVENTION

An object of the invention is to provide a protective device of the above mentioned type, which is capable of maintaining the flexible two-dimensional structure tightened in the pulled-out protective position.

The object is achieved in that the winding shaft is associated with a blocking device which is, by means of a control device, movable between a release position, releasing the winding shaft for rotational movement, and a securing position, blocking rotational movement of the winding shaft, in response to a displacement condition of the pull-out profile. According to the invention, the winding shaft can be blocked or released for rotational movement, depending on where the pull-out profile is located. Blocking of the winding shaft is in the pull-out direction of the two-dimensional structure, when the pull-out profile is shortly before reaching the pulled-out protective position of the two-dimensional structure. The pull-out profile can yet be transferred into its final position in order to reach the pulled-out protective position of the flexible two-dimensional structure, whereas the winding shaft is already blocked such that a further pull-out move of the pull-out profile results in the desired tightening of the flexible two-dimensional structure. In the reverse direction, the winding shaft is again released by the blocking device in order to initiate a winding up procedure of the two-dimensional structure by corresponding rotational movement. The blocking device and the control device can be implemented in a mechanical structure. It is also possible, to implement the blocking device and/or the control device in an electrical or electronic structure, wherein in particular the drive motor is capable of generating a blocking momentum for the winding shaft by corresponding electric power supply. The control device can control the drive motor electrically or electronically by means of corresponding sensor technology in an appropriate manner in order to achieve blocking or enabling of the drive motor.

The protective device according to the invention is provided for shading of glass pane areas of the vehicle interior, in particular for shading of vehicle rear window panes or vehicle side window panes or for shading of glass roof areas. As an alternative, the protective device according to the invention is provided for covering and/or partitioning of a loading compartment within the vehicle interior. Another embodiment of the invention is provided for covering a platform of a pick-up vehicle.

In an embodiment of the invention, the blocking device comprises a mechanical locking element capable of being taken in operative connection to the winding shaft. The locking element acts on the winding shaft or a supporting element connected to the winding shaft for conjoint rotation.

In a further embodiment of the invention, a spring force is applied to the locking element by means of a spring unit such that the locking element in a rest position is disengaged of the winding shaft. Thus, the locking element, when in its unstressed rest position, does not act on the winding shaft.

In a further embodiment of the invention, the control device engages the locking element in order to transfer the locking element from the rest position counter the spring force of the spring unit to a locking position relative to the winding shaft. Engagement of the control device on the locking element is to be understood as direct engagement by mechanical means, and also as indirect engagement by electrical or electronic wireless or wired means.

In a further embodiment of the invention, the control device includes a sensor unit which detects a position or a pathway of the pull-out profile shortly before reaching the protective position, and which is in connection with the locking element via remote transmission means in order to cause actuation of the locking element in the direction of the locking position in response to the detected position or the detected pathway of the pull-out profile. The control device and the sensor unit and also the remote transmission means can preferably be implemented by mechanical, electrical or electronic means.

In a further embodiment of the invention, the sensor unit includes a mechanical cam projecting into a movement path of the pull-out profile and, as a remote transmission means, a mechanical pull cord is provided extending between the cam and the locking element. The mechanical implementation of the sensor unit and the remote transmission means and, thus, also of the control device is cost-efficient and robust.

In a further embodiment of the invention, a tension spring means is integral to the mechanical pull cord, which tension spring means is provided for tensile force limitation of the pull cord. Preferably, the tension spring means is a helical tension spring.

In a further embodiment of the invention, the locking element is in the form of a pivoting ratchet and cooperating with a complementary support seat on the winding shaft. The support seat is preferably provided on a supporting element which is connected to the winding shaft for conjoint rotation. The ratchet is preferably retained in the disengaged rest position by a leg spring.

In a further embodiment of the invention, the pull-out profile is guided in lateral guiding rail arrangements, and the cam is mounted in one of the guiding rail arrangements to be slidable parallel to the movement path of the pull-out profile. In the ready-for-use installed condition of the protective device, the lateral guiding rail arrangements are disposed fixed to the vehicle. In case the protective device is provided for shading of a glass pane area of the vehicle interior, in particular for shading of a vehicle rear window, the guiding rail arrangements are provided on respective vehicle body pillar portions of the vehicle interior limiting the respective glass pane area.

### BRIEF DESCRIPTION OF THE DRAWINGS

Further advantages and features of the invention will become apparent from the claims and the description given below of preferred exemplary embodiments of the invention illustrated with reference to the drawings.

FIG. 1 shows schematically in a partial explosion view a first embodiment of a protective device according to the invention;

FIG. 2 shows, likewise in schematic illustration, another embodiment of a protective device according to the invention similar to FIG. 1;

FIG. 3 shows another embodiment of a protective device according to the invention similar to Pigs. 1 and 2;

FIG. 4 shows schematically in a side view the protective device according to FIG. 1 in a first operative condition;

FIG. 5 shows the protective device according to FIG. 4 in another operative condition; and

FIG. 6 shows the protective device according to FIGS. 4 and 5 in a third operative condition.

### DETAILED DESCRIPTION

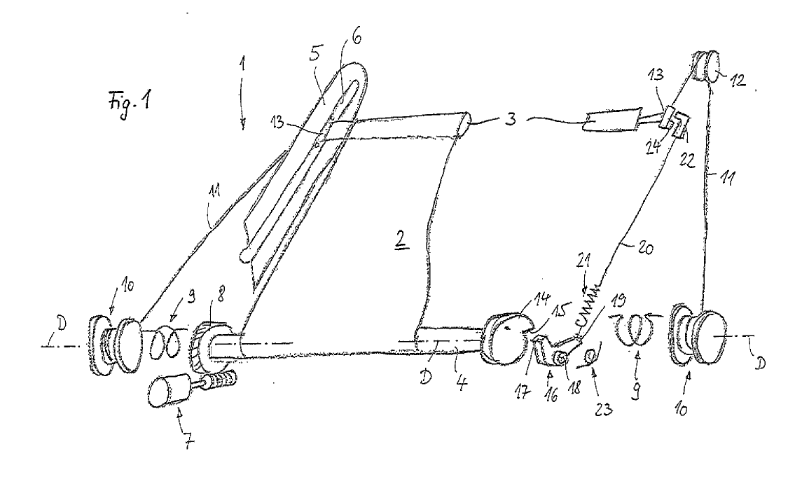

A protective device 1 according to FIGS. 1 and 4 to 6 is provided for shading of a rear window of a passenger motor vehicle. The protective device 1 comprises a flexible two-dimensional structure 2, which is mounted on a winding shaft 4 to be wound up and wound off. In the ready-for-use installed condition of the protective device 1, the winding shaft 4 is mounted within the vehicle interior in a support structure (not illustrated) to be rotating about a rotation axis D, wherein the support structure is positioned fixed to the vehicle. The support structure can, in particular, be a cartridge housing or a frame structure. The flexible two-dimensional structure 2 is fixed to the winding shaft 4 with an end face region that is in front in the winding-up direction. An opposite end face region that is in front in the winding-off direction and, thus, in the pull-out direction of the two-dimensional structure 2 is provided with a dimensionally stable pull-out profile 3, extending transverse to the pull-out direction over the entire width of the flexible two-dimensional structure 2. The pull-out profile 3 has on each of its opposite end faces a respective guiding element 13, mounted for longitudinal sliding displacement in a respective guiding track 6 in a respective lateral guiding rail arrangement 5. The opposed guiding rail arrangements 5, with merely the left hand side guiding rail arrangement 5 illustrated in the drawing of FIG. 1, are fixed to the vehicle on opposite body pillar portions, in the ready-for-use installed condition of the protective device 1.

The winding shaft 4 is driven in both directions of rotation relative to the rotation axis D by an electric drive motor 7 operatively connected to the winding shaft 4 by mechanical means. In the exemplary embodiment according to FIG. 1, a driving worm is held on the drive shaft of the drive motor 7 and combing a worm gear 8, which gear is connected to the winding shaft 4 for conjoint rotation and coaxially to the winding shaft 4.

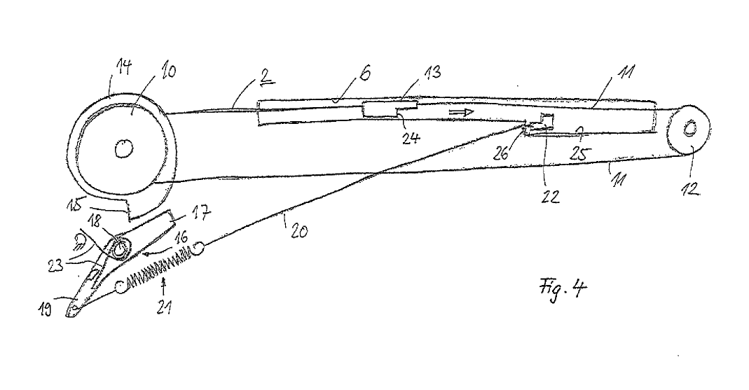

Likewise connected to the winding shaft 4 for conjoint rotation, a supporting element 14 is fixed on an end face region of the winding shaft 4 opposite to the worm gear 8 and provided with a support seat 15 designed in the form of a radial step. The supporting element 14 is positively entrained in both directions of rotation due to the coaxial and conjoint rotating connection to the winding shaft 4. The supporting element 14, implemented as a supporting disk, has an associated mechanical locking element 16, implemented as a ratchet, and mounted fixed to the vehicle by means of a pivot pin 18 pivoting about a pivot axis parallel to the rotation axis D. The ratchet 16 is positioned by a spring unit, present in the form of a leg spring 23, in the unstressed rest position disengaged of the supporting disk 14 and the support seat 15, as illustrated in FIG. 4. The leg spring 23 is designed such that a clockwise torque is exerted on the ratchet 16, as apparent in the illustrations according to FIGS. 4 to 6, whereby a locking leg 17 of the ratchet 16 is held in a radial distance to the supporting disk 14 and the support seat 15.

The ratchet 16 has, opposite to the locking leg 17, an actuating leg 19 projecting relative to the pivot pin 18 essentially opposed to the locking leg 17 radially in relation to the pivot axis of the ratchet 16. A mechanical pull cord 20 in the form of an actuation cable engages the actuating leg 19. Integrated in the mechanical pull cord 20 is a tension spring means 21 in the form of a helical tension spring in order to achieve spring-loaded pathway compensation and tensile force limitation of the pull cord 20.

The pull cord 20 is solidly connected to a cam 22, on its face end opposite to the actuating leg 19, said cam is displaceably mounted in a slide guiding portion 25 of the guide rail arrangement in parallel to the guiding member 13 of the pull-out profile 3. The slide guiding portion 25 is limited in the direction towards the winding shaft 4 by a step-type abutment stop 26, in order to limit a longitudinal move of the cam 22. The cam 22 is positioned for the guiding member 13 of the pull-out profile in an end region of the guiding track 6, where the pull-out profile 3 is located shortly before reaching the pulled-out protective position for the two-dimensional structure 2. The guiding member 13 is provided with an entrainment bar 24 which projects in the trajectory of the cam 22 and, as a result, entrains the cam 22 during transfer of the pull-out profile 3 and the lateral guiding member 13 in the direction of the pulled-out protective position of the two-dimensional structure 2, as soon as the guiding member 13 has reached an end region of its traveling pathway in the direction towards the pulled-out protective position.

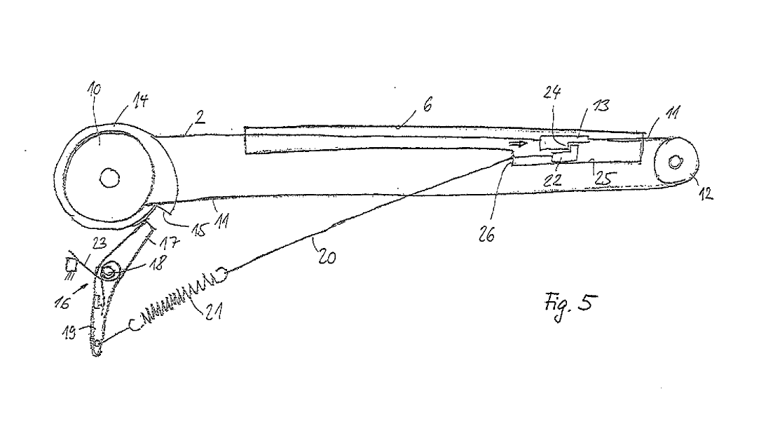

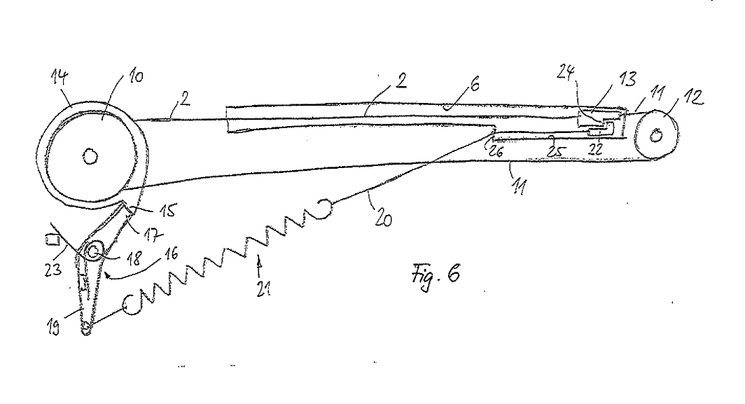

With reference to FIGS. 4 to 6 it is apparent which movement procedures occur during a transfer of the pull-out profile 3 and, thus, of the guiding member 13 to the pulled-out protective position in the final zone of the traveling pathway. As soon as the guiding member 13, starting from FIG. 4, moves further on in the direction of the arrow, the entrainment bar 24 abuts on the cam 22 and entrains the cam 22 in the movement direction of the guiding member 13 and, thus, of the pull-out profile 3. Thereby, a tensile force is exerted on the pull cord 20, which force is transmitted to the actuating leg 19 of the locking element 16. By this means, a torque about the pivot pin 18 is exerted counter the spring force of the leg spring 23, counter-clockwise in FIG. 5, whereby the locking leg 17 is tangentially urged against a periphery of the supporting disk 14 and comes to rest thereon. During a further pull-out procedure of the two-dimensional structure 2 the winding shaft and, thus, also the supporting disk 14 are further turned clockwise according to FIGS. 4 to 6, whereby the support seat 15 abuts on an end face of the locking leg 17 in the circumferential direction (FIG. 6). Thereby, further rotating movement of the winding shaft and the supporting disk 14 is blocked. The pull-out profile 3 together with its guiding member 13, however, may be moved further on up to its final position in the guiding track 6, i.e., up to the pulled-out protective position, as will be explained below, whereby necessarily the two-dimensional structure 2 is tightened in the pull-out direction. The pull cord 20 is also tightened, wherein a corresponding compensation of length and limitation of the tensile force by according action of the tension spring means 21 in the form of the helical compression spring are balanced.

When the pull-out profile is moved back again in the inverse direction, the tensile force acting on the actuating leg 19 is overridden and the leg spring 23 leads the ratchet 16 out of the support seat 15 again, whereby rotary movement of the winding shaft 4 in the winding-up direction of the two-dimensional structure 2 is enabled.

As is apparent with reference to FIG. 1, the pull-out profile 3 is also driven by drive transmission means 11, with the drive force thereof derived from drive motor 7. In the embodiment according to FIGS. 1 and 4 to 6, a respective cable line 11 engages each guiding member 13 of the pull-out profile within each guiding rail arrangement 5, said cable line exerting a tensile force on the respective guiding member 13 in the pull-out direction. For that purpose, the respective cable line 11 is deflected via a respective deflection pulley 12 on an end face region of the respective guiding rail arrangement 5 that is in front in the pull-out direction. Each cable line 11 is held on a cable drum 10 for winding up and off, wherein the two cable drums 10 are disposed coaxially to the rotation axis D of the winding shaft 4 and are in rotating connection to the winding shaft 4 via a respective balance spring 9. The respective balance spring 9 is a torsion spring and causes torque transmission of the torque of the winding shaft 4 and, thus, of the torque of the drive motor 7 to the respective cable drum 10. Likewise, the respective balance spring 9 also allows rotation of the respective cable drum 10 independent of the winding shaft 4 with simultaneous tensioning of the respective balance spring 9. Thereby, the cable lines 11 are kept under permanent tension and exert permanent tensional stress on the guiding members 13 of the pull-out profile 3. As a result, the balance springs 9 ensure also that the cable drums 10 and, thus, the cable lines 11 are yet capable of transferring the pull-out profile 3 and the guiding members 13 up to the pulled-out final position, i.e., the pulled-out protective position, even after blocking of the winding shaft 4 by engagement of the ratchet 16 in the supporting disk 14.

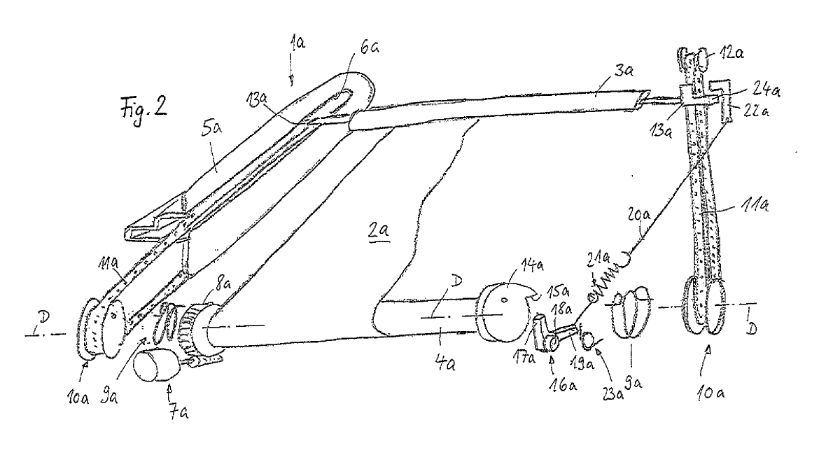

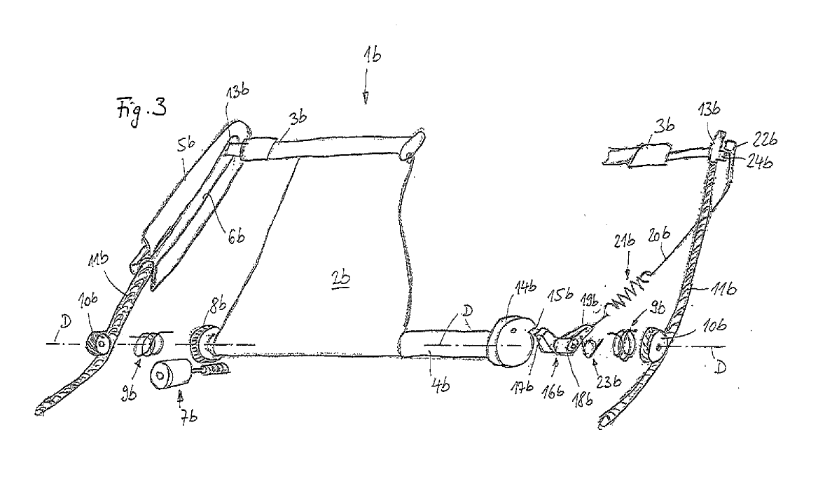

The protective devices 1a and 1b according to FIGS. 2 and 3 are identical to the protective device 1 according to FIGS. 1 and 4 to 6, with the exception of the drive transmission means acting on the respective pull-out profile 3a, 3b. Parts and portions of the protective devices 1a and 1b of identical design or similar function are identified by similar reference numerals with the letter “a” or “b” added thereto. To avoid repetitions, reference is made to the detailed description in relation to the protective device 1 according to FIGS. 1 and 4 to 6. The protective device 1a according to FIG. 2 has a closed revolving pulling belt 11a for a drive transmission means instead of an open cable line. The merely schematic illustration according to FIG. 2 gives the impression that the right hand side pulling belt 11a has an orientation differing from that of the left hand side pulling belt 11a. This is merely for reasons of graphic illustration. Of course, the right hand side pulling belt 11a extends in parallel to the opposite pulling belt 11a. The function and operation of the control device and the blocking device for blocking the winding shaft 4a are identical to that of the blocking device and control device according to FIGS. 1 and 4 to 6.

With the protective device 1b according to FIG. 3 a flexible threaded shaft 11b is provided on each side as drive transmission means capable of transmitting tensile and compressive stresses. The threaded shafts 11b are also referred to as flexshafts. The threaded shafts 11b are each driven by a respective worm wheel 10b which is operatively coupled for conjoint rotation to a winding shaft 4b via the respective balance spring 9b. The respective worm wheel 10b is in operative connection to the winding shaft 4b coaxially to the rotation axis D. The threaded shafts 11b push the guiding members 13 in the guiding tracks of the guiding rail arrangements 5b along the pull-out direction, due to the force transmission via the worm wheels 10b. The function and operation of control device and blocking device for blocking and releasing the winding shaft 4b are identical to the embodiment according to FIGS. 1 and 4 to 6.

1. A protective device for an automotive vehicle, in particular for a vehicle interior, comprising a flexible two-dimensional structure, which is held on a winding shaft and is movable between a pulled-out protective position and a rest position wound-up on the winding shaft, wherein the winding shaft is driven by means of a drive motor in both directions of rotation, wherein the two-dimensional structure is provided with a dimensionally stable pull-out profile in the end face region that is in front in the pull-out direction, and wherein drive transmission means are provided, which engage the pull-out profile and are in operative connection to the winding shaft, wherein the winding shaft is associated with a blocking device which is, by means of a control device, movable between a release position, releasing the winding shaft for rotational movement, and a securing position, blocking rotational movement of the winding shaft, in response to a displacement condition of the pull-out profile.

2. The protective device according to claim 1, wherein the blocking device comprises a mechanical locking element capable of being taken in operative connection to the winding shaft.

3. The protective device according to claim 2, wherein a spring force is applied to the locking element by means of a spring unit such that the locking element in a rest position is disengaged of the winding shaft.

4. The protective device according to claim 3, wherein the control device engages the locking element in order to transfer the locking element from the rest position counter the spring force of the spring unit to a locking position relative to the winding shaft.

5. The protective device according to claim 1, wherein the control device includes a sensor unit which detects a position or a pathway of the pull-out profile shortly before reaching the protective position, and which is in connection with the locking element via remote transmission means in order to cause actuation of the locking element in the direction of the locking position in response to the detected position or the detected pathway of the pull-out profile.

6. The protective device according to claim 5, wherein the sensor unit includes a mechanical cam projecting into a movement path of the pull-out profile, and in that a mechanical pull cord is provided as a remote transmission means extending between the cam and the locking element.

7. The protective device according to claim 6, wherein a tension spring means is integral to the mechanical pull cord, which tension spring means is provided for tensile force compensation of the pull cord.

8. The protective device according to claim 1, wherein the locking element is designed as a pivoting ratchet and cooperates with a complementary support seat on the winding shaft.

9. The protective device according to claim 1, wherein the pull-out profile is guided in lateral guiding rail arrangements, and in that the cam is mounted in one of the guiding rail arrangements to be slidable parallel to the movement path of the pull-out profile.
